(19) United States
(12) Patent Application Publication
(10) Pub. No.: US 2010/0231585 A1
(43) Pub. Date: Sep. 16, 2010

(54) Systems and Methods for Processing Graphics Primitives

(75) Inventor: Michael E. Weiblen, Boulder, CO (US)

Correspondence Address: Georgios A. Georgakis;Chowdhury & Georgakis, PC, PO BOX 90277, AUSTIN, TX, 78709-0277, US

(73) Assignee: Zebra Imaging, Inc., Austin, TX (US)

(21) Appl. No.: 12/404,160

(22) Filed: Mar. 13, 2009

(51) Int. Cl. G06T 17/10

(52) U.S. Cl. 345/420

(57) ABSTRACT

Methods and systems for processing graphics primitives, including point-reflecting a graphics primitive about a point to generate a reflected graphics primitive, the reflected graphics primitive maintaining a depth information of the graphics primitive.

### BACKGROUND

The invention relates generally to the field of processing computer graphics primitives.

### SUMMARY

In one respect, disclosed is a method for processing graphics primitives, the method comprising point-reflecting a graphics primitive about a point to generate a reflected graphics primitive, the reflected graphics primitive maintaining a depth information of the graphics primitive.

In another respect, disclosed is a system for rendering a hogel, the system comprising: one or more processors; and one or more memory units coupled to the one or more processors, the system being configured to: point-reflect a graphics primitive about a point to generate a reflected graphics primitive, the reflected graphics primitive maintaining a depth information of the graphics primitive.

In yet another respect, disclosed is a computer program product stored on a computer operable medium, the computer program product comprising software code being effective to: point-reflect a graphics primitive about a point to generate a reflected graphics primitive, the reflected graphics primitive maintaining a depth information of the graphics primitive.

Numerous additional embodiments are also possible. In one or more various aspects, related articles, systems, and devices include but are not limited to circuitry, programming, electro-mechanical devices, or optical devices for effecting the herein referenced method aspects; the circuitry, programming, electro-mechanical devices, or optical devices can be virtually any combination of hardware, software, and firmware configured to effect the herein referenced method aspects depending upon the design choices of the system designer skilled in the art.

The foregoing is a summary and thus contains, by necessity, simplifications, generalizations and omissions of detail; consequently, those skilled in the art will appreciate that the summary is illustrative only and is not intended to be in any way limiting. Other aspects, features, and advantages of the devices, processes, or other subject matter described herein will become apparent in the teachings set forth herein.

In addition to the foregoing, various other method, device, and system aspects are set forth and described in the teachings such as the text (e.g., claims or detailed description) or drawings of the present disclosure.

### BRIEF DESCRIPTION OF THE DRAWINGS

Other aspects and advantages of the invention may become apparent upon reading the detailed description and upon reference to the accompanying drawings.

FIG. 1 is a block diagram illustrating a system for processing graphics primitives, in accordance with some embodiments.

FIG. 2 is a block diagram illustrating a system for processing and rendering graphics primitives into hogel data, in accordance with some embodiments.

FIG. 3 is a graphical representation in 4D homogeneous space illustrating the processing of graphics primitives located in the primary region and the processing of graphics primitives located in the secondary region, in accordance with some embodiments.

FIG. 4 is a graphical representation in 4D homogeneous space illustrating the processing of a graphics primitive located in both the primary and secondary regions, in accordance with some embodiments.

FIG. 5 is a graphical representation illustrating regions that may be used to classify and accordingly process graphics primitives, in accordance with some embodiments.

FIG. 6 is a flow diagram illustrating a method for processing graphics primitives, in accordance with some embodiments.

FIG. 7 is a flow diagram illustrating a method for processing graphics during hogel rendering, in accordance with some embodiments.

FIG. 8 is a flow diagram illustrating an alternative method for processing graphics primitives during hogel rendering, in accordance with some embodiments.

FIG. 9 is a flow diagram illustrating yet another alternative method for processing graphics primitives during hogel rendering, in accordance with some embodiments.

Brief description for the additional figures is provided in the detailed description section.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### DETAILED DESCRIPTION

Certain terms are used throughout the following description and claims to refer to particular system components and configurations. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the terms “couple,” “couples,” “coupled,” or “coupleable” are intended to mean either an indirect or direct electrical or wireless connection. Thus, if a first device couples to a second device, that connection may be through a direct electrical, optical, wireless connection, etc. or through an indirect electrical, optical, wireless connection, etc. by means of other devices and connections.

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art. Other embodiments may be utilized, and other changes may be made, without departing from the spirit or scope of the subject matter presented here.

In some embodiments, systems and methods are disclosed for processing graphics primitives and more particularly point-reflecting graphics primitives about a point while maintaining a depth information of the graphics primitives. Accordingly, a spatial position of the graphics primitive may change but since the depth information is preserved the relative occlusion between the graphics primitives is preserved, thus resulting in the correct relative overlay of the graphics primitives in 2D projections. In some embodiments, such depth-preserving point-reflection of graphics primitives may be implemented to point-reflect a subset of the graphics primitives during or before the rendering of the graphics primitives into hogel views.

In some embodiments, multiple hogel views on a holographic plane or surface may be rendered by considering virtual cameras on the holographic plane placed at the hogel locations. It should be noted that since a hogel, as implemented, may have a 2D spatial extend, hogel location may refer to the location of the center of the hogel or hogel point.

For each hogel, two views may be considered and then merged to form the hogel view. A first view may be generated by facing the camera towards one side of the holographic surface, and a second view may be generated by facing the camera towards the other side of the holographic surface. Appropriate transformations to account for the reversed or conjugate view from one of the cameras may be applied. The two views may also be referred to as orthoscopic and pseudoscopic views. In some embodiments, rasterization techniques may be used to render the graphics primitives into hogel views. For additional discussion on hogel rendering, please see U.S. Pat. No. 6,366,370, filed Apr. 2, 2002, entitled “RENDERING METHODS FOR FULL PARALLAX AUTOSTEREOSCOPIC DISPLAYS” and naming Mark Holzbach, et al. as inventors. The above-referenced patent application is hereby incorporated by reference herein in its entirety.

In alternative embodiments, the graphics primitives may be analyzed and preprocessed prior to or during the rendering in order to optimize the rendering process. Optimizing the rendering process may result, for example, in increased rendering speed and quality. The 3D space may be subdivided into two or more regions, for example, and the graphics primitives may be preprocessed according to which region, the graphics primitives, at least partially, intersect. Examples of such processing may include moving and/or duplicating the graphics primitives from one region to another region (using depth-preserving point reflections, for example), replacing the graphics primitives with other equivalent graphics primitives, etc. In addition, different rendering techniques (such as different projections, for example) may be implemented in different regions.

In some embodiments, two regions may be used: one above and one below the holographic plane. In such embodiments, for each primitive, a determination may be first made as to which region a primitive, at least partially intersects. One region, either the region in front or the region behind the holographic surface, may be designated as the primary region while the other region may be designated as the secondary region. In some embodiments, if a primitive is located at least partially in the secondary region, the graphics primitive may be point-reflected about the hogel location, thereby creating an additional graphics primitive that is, at least partially, in the primary region. In some embodiments, the duplication and point-reflection of the graphics primitive maintains the depth to ensure proper relative overlay placement of the graphics primitive (over or under, for example) other primitives during the creation of the 2D hogel views.

In other embodiments, the graphics primitives may be duplicated regardless of region. That is, all the graphics primitives are duplicated and reflected, thereby duplicating primitives in the primary region to the secondary region and graphics primitives in the secondary region to the primary region.

In some embodiments, appropriately duplicating the graphics primitive information from the secondary region into the primary region allows the use of a single camera (the camera facing the primary region, for example) during the rendering. Doing so may improve the rendering speed and efficiency without the loss of any graphics primitive information.

In some embodiments, the duplication, reflection, and general processing of the graphics primitives may be accomplished using a customized application created and configured to perform this operation. In other embodiments, functionality available in current GPUs may be used implement the graphics primitives processing. For example, geometry shaders provided with certain GPUs (for example, GPUs that support OpenGL version 2 and/or Direct3D version 10 application programming interfaces) may be used to accomplish graphics primitives processing such as the duplication and point reflection as well as other types of graphics primitive processing. In some embodiments, hardware/software on the graphics processing unit, outside of graphics languages such as OpenGL and Direct3D, may be used to implement the processing of the graphics primitives.

In some embodiments, an additional “epsilon region” may be considered for each hogel in order to better process the singularity that may occur at the hogel position. Such singularity may be the result of a division by zero resulting from the perspective division or homogeneous normalization that may be part of the rendering process, for example. In some embodiments, the third region may be a substantially small region centered around the holographic surface. For example, the epsilon region may be a region that extends along the holographic surface but has a substantially small width along the view direction perpendicular to the hogel surface.

In some embodiments, a determination may be made as to whether a primitive intersects the epsilon region. If a primitive does intersect the epsilon region, one or more additional graphics primitives may be created and added to set of graphics primitives. In some embodiments, two triangular primitives may be added that together form a square. In other embodiments, a single triangle or other combinations of graphics primitives may be used to replace the original graphics primitive. In some embodiments, the one or more additional graphics primitives may be assigned attributes that are interpolations, for example, of the attributes of the vertices of the original graphics primitive. In some embodiments, the attributes of the graphics primitives may include interpolated depth attributes from the original graphics primitive in order to correctly overlay the additional graphics primitives with other primitives in the rendering volume.

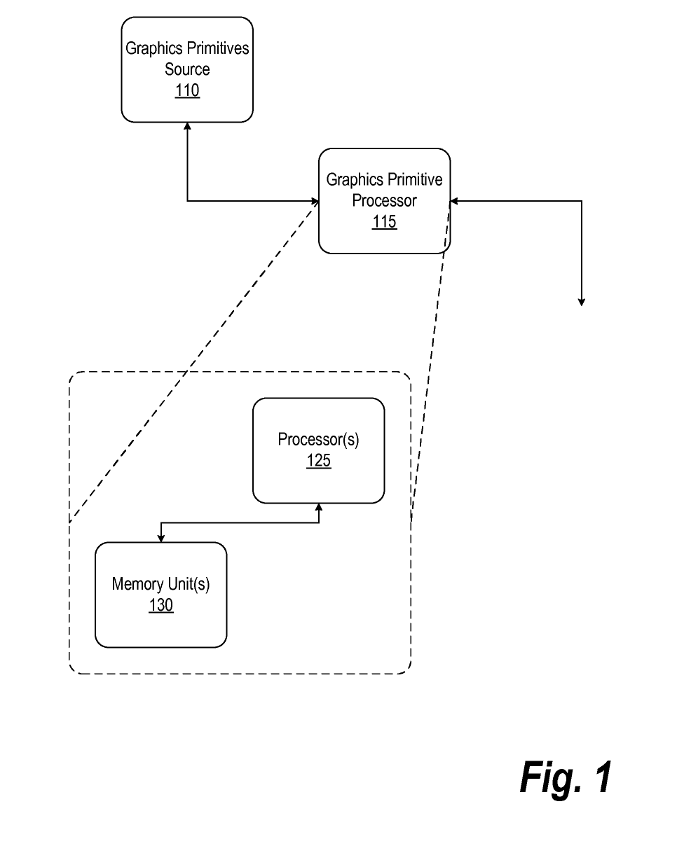

FIG. 1 is a block diagram illustrating a system for processing graphics primitives, in accordance with some embodiments.

In some embodiments, graphics primitive processor 115 is configured to receive graphics primitives from graphics primitive source 110 and process the graphics primitives. In some embodiments, graphics primitive processor 115 may be implemented using one or more processors 125 and one or more memory units 130, which are coupled to one or more processors 125.

In some embodiments, graphics processor 115 may be configured to point-reflect graphics primitives about a point while maintaining a depth information of the graphics primitives. Accordingly, a spatial position of the graphics primitive may change but since the depth information is preserved the relative occlusion and overlay between the graphics primitives is preserved. In some embodiments, such depth-preserving point-reflection of graphics primitives may be applied to a subset of the graphics primitives during or before the rendering of the graphics primitives into hogel views. In some embodiments, graphics primitive processor 115 may, for example, be configured to point-reflect the spatial coordinates (x, y, and z) of the vertices of the graphics primitives while maintaining the value of the homogeneous coordinate (w) of the vertices.

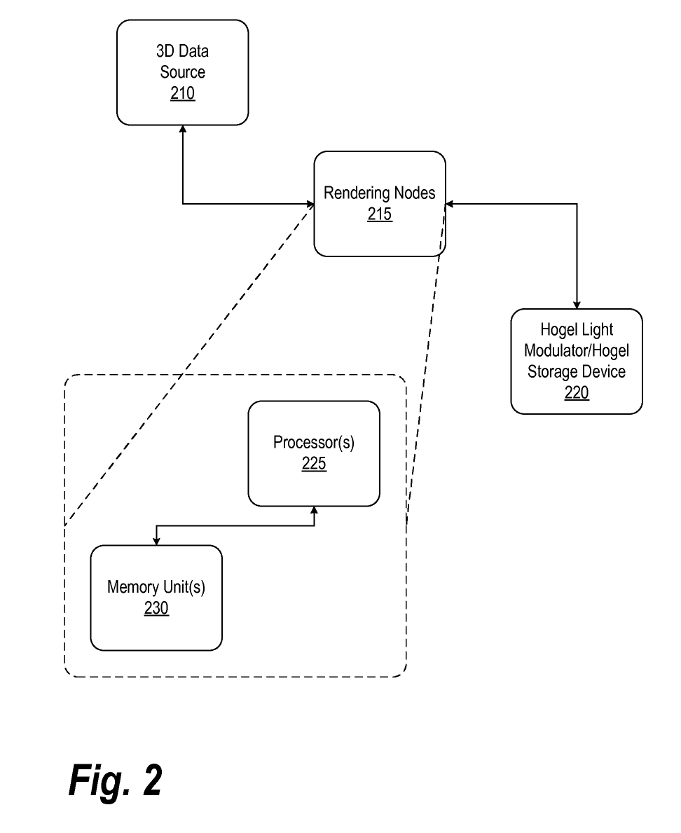

FIG. 2 is a block diagram illustrating a system for processing and rendering graphics primitives into hogel data, in accordance with some embodiments.

In some embodiments, rendering nodes 215 are configured to receive 3D graphics data/commands from 3D data source 210 and to render the 3D data into multiple hogel 2D views. In some embodiments, rendering nodes 215 may comprise one or more graphics processing units configured to convert the 3D data into hogel data in parallel and/or in series. In some embodiments, the rendering nodes may be configured to additionally process the graphics primitives provided by 3D data source 210. In some embodiments, the functionality of rendering nodes 215, including the functionality of processing graphics primitives, may be implemented using processors 225 and memory units 230 that are coupled to the processors 225.

In some embodiments, two regions may be considered: one above and one below the holographic surface (or in front and behind the holographic surface). In some embodiments, two rendering frusta may be used for each hogel: one above and one below the holographic plane. In some embodiments, the two frusta may be opposite-facing square-base pyramids having apexes at each hogel location. In some embodiments, a determination may be then made as to which region each primitive, at least partially, intersects. One region may be chosen as the primary region while the other region may be designated as the secondary region. In some embodiments, if a primitive is at least partially in the secondary region, the graphics primitive is duplicated and point-reflected about the hogel, creating an additional graphics primitive that is now, at least partially, in the primary region. During the duplication and point-reflection of the graphics primitive, information about the depth of the graphics primitive is maintained in order to ensure a proper relative overlay of the graphics primitive (over or under, for example) other primitives during the creation of the 2D hogel view.

In some embodiments, the depth-preserving point reflection may be accomplished by point-reflecting the spatial coordinates of each vertex of a primitive while maintaining the value of the homogeneous coordinate. For example, if the reflection point (the hogel) is assumed to be at the origin, the point reflection may be implemented by changing the sign of the x, y, and z coordinates of the vertices of a primitive while preserving the w coordinate. In other embodiments, a combination of the z and w values may be used to represent and maintain depth information. In other embodiments, all coordinates (including the homogeneous coordinate) may be point-reflected. In such embodiments, the preservation of the depth information may be accomplished, for example, by using an additional database to store such information or by appropriately setting a flag associated with the vertices of the graphics primitive.

In some embodiments, appropriately duplicating the graphics primitive information from the secondary to the primary region enables the use of a single camera (the camera facing the primary region, for example) during the rendering. Doing so may improve the rendering speed and efficiency without the loss of any graphics primitive information.

In some embodiments, an “epsilon” region may be considered for each hogel in addition to the primary and secondary regions. In some embodiments, the epsilon region may be a substantially small region substantially close to the holographic surface. For example, the epsilon region may be a very small parallelepiped extending from −ε to ε along the view axis above and below the holographic surface, where ε is a substantially small quantity.

In some embodiments, a determination may be made as to whether a primitive at least partially intersects the epsilon region. If a primitive does intersect the epsilon region, one or more additional graphics primitives may be created and added to set of graphics primitives to replace the original graphics primitive. In some embodiments, one or more graphics primitives may be added that cover the epsilon region, for example. In embodiments where the epsilon region is a parallelepiped, two triangular primitives may be added that together form a square across the epsilon region. In some embodiments, the one or more additional graphics primitives may be assigned attributes (including depth) that are interpolations, for example, of the attributes of the vertices of the original graphics primitive.

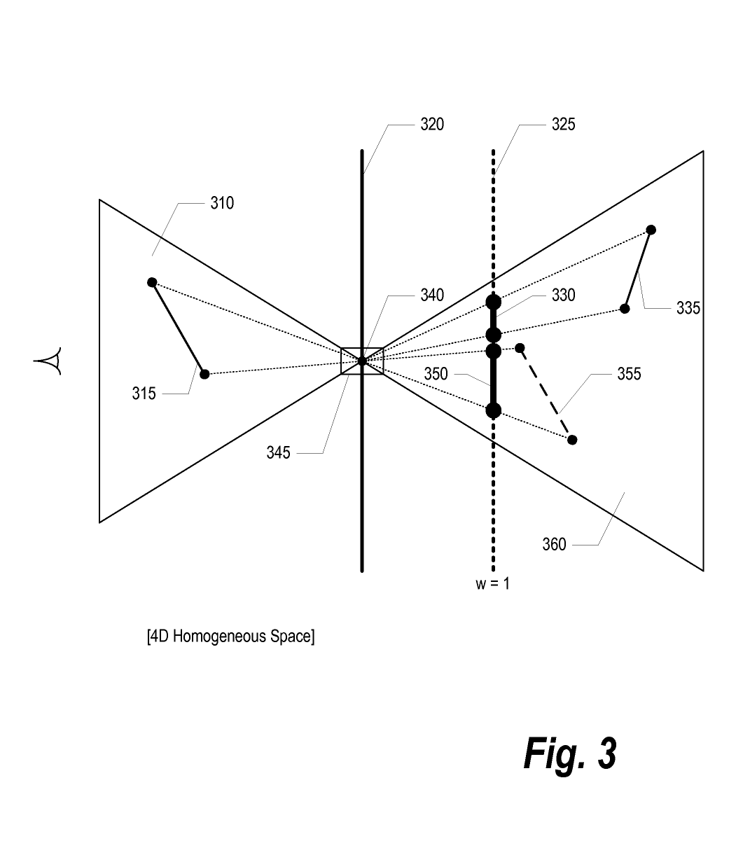

FIG. 3 is a graphical representation in 4D homogeneous space illustrating the processing of graphics primitives located in the primary region and the processing of graphics primitives located in the secondary region, in accordance with some embodiments.

The figure illustrates examples of how graphics primitives in different regions may be treated during the rendering of a hogel view. Orthoscopic frustum 360 may be on the side of the holographic plane away from the observer and pseudoscopic frustum 310 may be on the opposite side. Epsilon rendering volume 345 may be a substantially small rendering volume located very close to the hogel location. In this example, the horizontal axis may represent the homogeneous coordinate and the vertical axis may represent any of the spatial coordinates.

In some embodiments, two regions may be considered: a primary region on the side of holographic plane 320 away from the observer and a secondary region on the other side of holographic plane 320. For each primitive, a determination may be made as to which region a graphics primitive at least partially intersects. Primitive 335, for example, is located in the primary region and thus no additional processing is performed for that graphics primitive. Primitive 335 may be then projected onto plane 325 to create projection 330, which is to be combined with projections from other primitives in the process of creating a hogel view for hogel 340. In some embodiments, plane 325 may be located at w=1.

Primitive 315, on the other hand, is located in secondary region. Accordingly, graphics primitive 315 is duplicated and point-reflected about hogel 340 to generate reflected graphics primitive 355, which is located in the primary region. Primitive 355 is then projected onto plane 325 to create projection 350, which is also to be combined with projections from other primitives in the process of creating a hogel view for hogel 340. Rendering may now be accomplished by considering only one virtual camera facing the primary.

In some embodiments, a third epsilon region may be considered in classifying and processing graphics primitives. If a primitive intersects the epsilon region, one or more additional graphics primitives may be created and added to set of graphics primitives. In some embodiments, two triangular primitives may be added that together form a square across the epsilon rendering volume 345. In some embodiments, the one or more additional graphics primitives may be assigned attributes (including depth) that are interpolations of the attributes of the vertices of the original graphics primitive. In some embodiments, the graphics primitives may be assigned a homogeneous coordinate value of 1, which is equivalent to an orthographic projection.

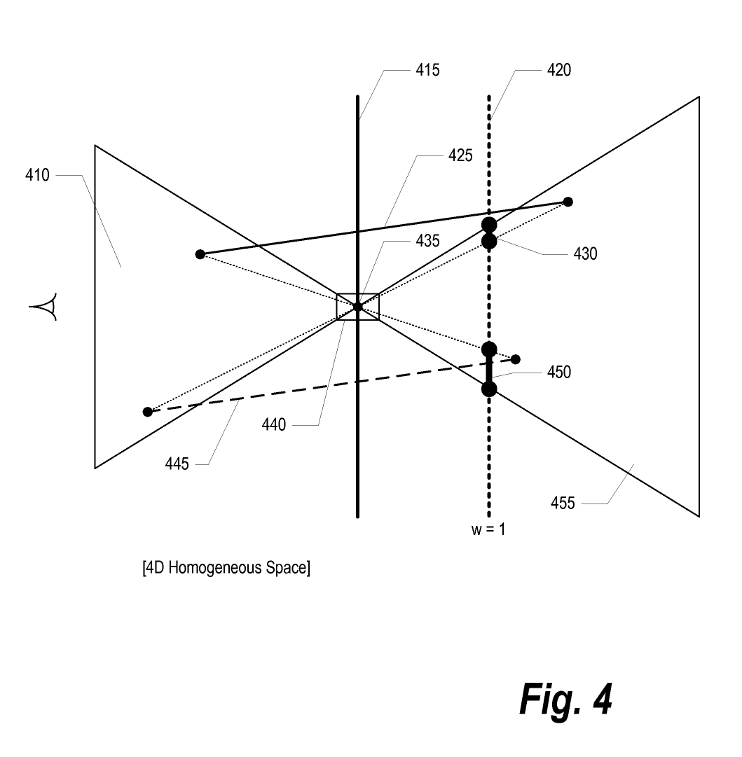

FIG. 4 is a graphical representation in 4D homogeneous space illustrating the processing of a graphics primitive located in both the primary and secondary regions, in accordance with some embodiments.

The figure illustrates an example of how a primitive intersecting both the primary and secondary regions may be treated during the rendering of a hogel view. Orthoscopic frustum 455 may be on the side of the holographic plane away from the observer and pseudoscopic frustum 410 may be on the other side. Epsilon rendering volume 440 may be a substantially small third region located substantially close to the hogel location. In this example, the horizontal axis may represent the homogeneous coordinate and the vertical axis may represent any one of the spatial coordinates.

In some embodiments, two regions may be considered: a primary region on the side of holographic plane 415 away from the observer and a secondary region on the other side of holographic plane 415. For each primitive, a determination may be made as to which region each of the 3D graphics at least partially intersects. Primitive 425, for example, is located both in the primary and secondary regions. Accordingly, the graphics primitive is duplicated and reflected to create reflected graphics primitive 445. And since the original graphics primitive and the reflected graphics primitive are, at least partially, located in the primary region, both original graphics primitive 425 and reflected graphics primitive 445 are projected onto plane 420. The projections may be then combined with projections from other primitives in the process of creating a hogel view for hogel 435. In some embodiments, plane 420 may be located at w=1.

In some embodiments, a third epsilon region may be considered in classifying and processing graphics primitives. If a primitive intersects the epsilon region, one or more additional graphics primitives may be created and added to set of graphics primitives. In some embodiments, two triangular primitives may be added that together form a square across the epsilon rendering volume 440. In some embodiments, the one or more additional graphics primitives may be assigned attributes (including depth) that are interpolations of the attributes of the vertices of the original graphics primitive. In some embodiments, the graphics primitives may be assigned a homogeneous coordinate value of 1, which is equivalent to an orthographic projection.

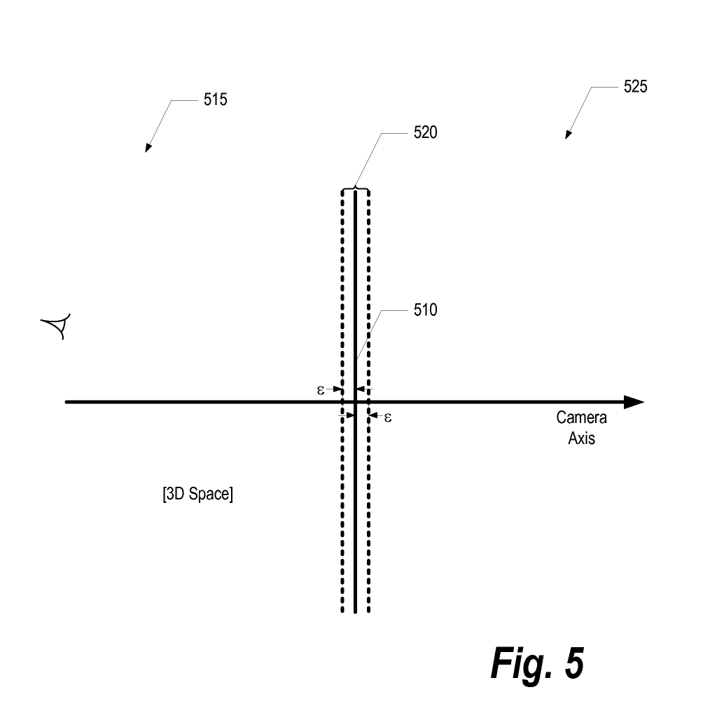

FIG. 5 is a graphical representation illustrating regions that may be used to classify and accordingly process graphics primitives, in accordance with some embodiments.

The regions as shown here are only one example of the regions that may be used to classify and accordingly process graphics primitives. In some embodiments, two regions may be defined: region 515 may be a region on the side of holographic surface 510 facing the observer and region 525 may be a region on the other side of holographic surface 510. In addition, a third epsilon region 520 may be defined, region 520 extending a substantially small value E above and below holographic surface 510. The regions may be used to classify the graphics primitives and accordingly process the graphics primitives according to the methods and the systems described here.

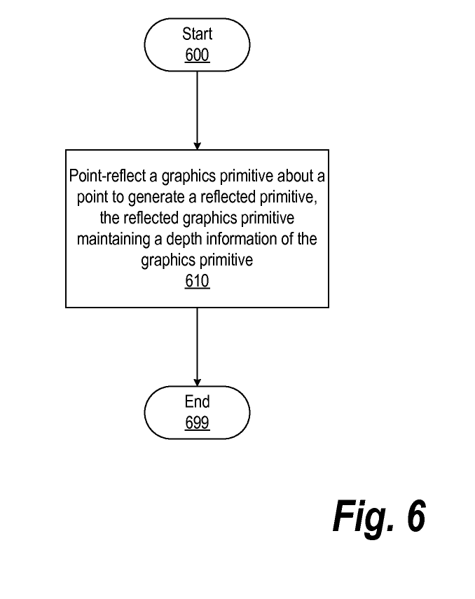

FIG. 6 is a flow diagram illustrating a method for processing graphics primitives, in accordance with some embodiments. It should be noted that, in some embodiments, the methods described here may be performed by the system described in FIG. 1 or FIG. 2.

Processing begins at 600 where, at block 610, a graphics primitive is point-reflected about a point to generate a reflected graphics primitive. The reflected graphics primitive maintaining a depth information of the graphics primitive. Processing subsequently ends at 699.

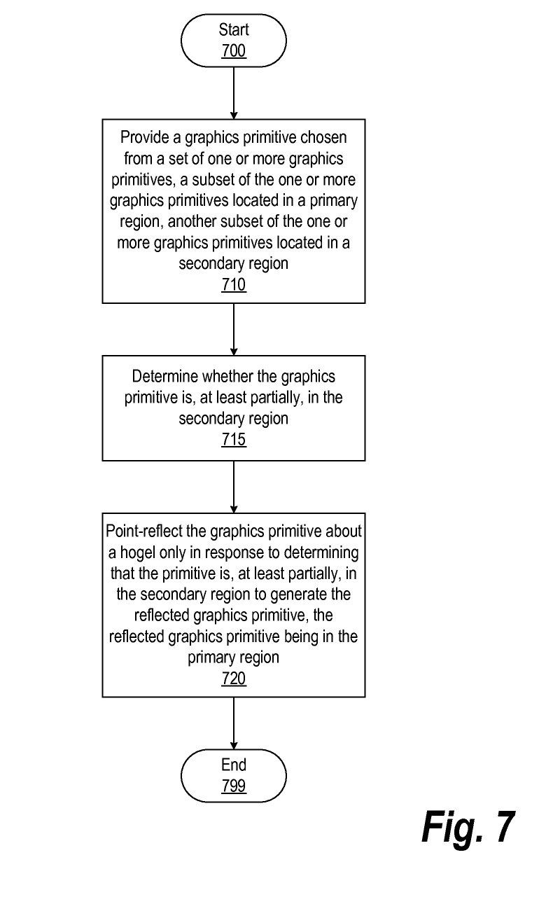

FIG. 7 is a flow diagram illustrating a method for processing graphics during hogel rendering, in accordance with some embodiments. It should be noted that, in some embodiments, the methods described here may be performed by the system described in FIG. 1 or FIG. 2.

Processing begins at 700 whereupon, at block 710, a graphics primitive is provided, the graphics primitive being chosen from a set of one or more graphics primitives. A subset of the one or more graphics primitives is located in a primary region, and another subset of the one or more graphics primitives is located in a secondary region.

At block 715, a determination is made as to whether the graphics primitive is, at least partially, in the secondary region. At block 720, the graphics primitive is point-reflected about a hogel only in response to determining that the graphics primitive is, at least partially, in the secondary region to generate a reflected graphics primitive, the reflected graphics primitive being in the primary region.

Processing subsequently ends at 799.

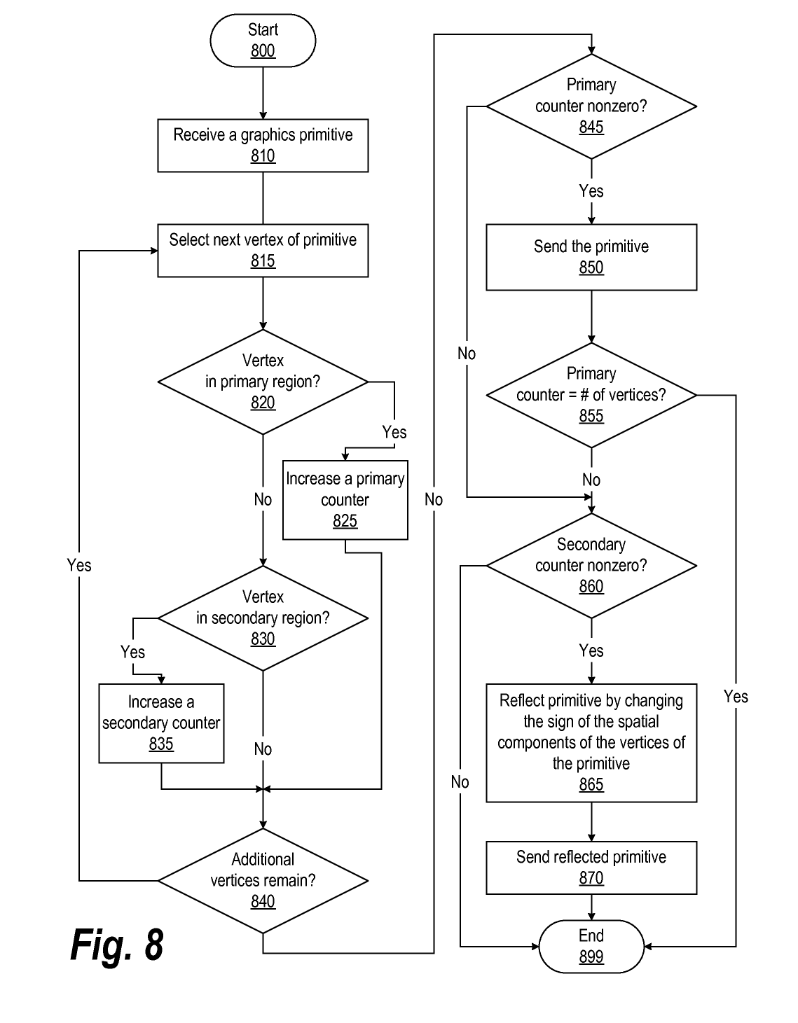

FIG. 8 is a flow diagram illustrating an alternative method for processing graphics primitives during hogel rendering, in accordance with some embodiments. It should be noted that, in some embodiments, the methods described here may be performed by the system described in FIG. 1 or FIG. 2.

Processing begins at 800 whereupon, at block 810, a graphics primitive is received. At block 815, the next vertex of the graphics primitive is selected, and at decision 820, a determination is made as to whether the vertex depth places vertex in the primary region. That is, a determination is made as to whether the vertex is located the region above or below the hogel plane that was designated as the primary region. It should be noted that in this example, the region below the holographic surface (away from the observer) is designated as the primary region and the region above the holographic surface (towards the observer) is designated as the secondary region. If the vertex depth places vertex in primary region, processing continues at block 825 where a primary counter is increased to keep track of the number of vertices in the primary region. Processing subsequently continues at decision 840.

On the other hand, if the vertex depth does not place vertex in the primary region, processing continues to decision 830 where a determination is made as to whether the vertex depth places the vertex in the secondary region. If the vertex depth places vertex in the secondary region, processing continues at block 835 where a secondary counter is increased to keep track of the number of vertices being in the secondary region.

On the other hand, if the vertex depth does not place vertex in the secondary region, processing continues at decision 840 where a determination is made as to whether additional vertices remain. If additional vertices remain, processing returns to block 815 where the next vertex of the graphics primitive is selected for processing.

On the other hand, if no additional vertices remain, processing continues at decision 845 where a determination is made as to whether the primary counter (indicating the number of vertices being in the primary region) is nonzero. If the primary counter is nonzero, processing continues at 850 where the graphics primitive is forwarded unchanged for further processing. On the other hand, if the primary counter is zero, processing continues at decision 860.

At decision 855, a determination is made as to whether the primary counter is equal to the number of vertices of the graphics primitive, an indication that all the vertices are in the primary region. If the primary counter is equal to the number of vertices, processing skips to the end where processing ends at 899. It should be noted that this determination is optional and is only required for more efficient and optimized processing.

If the primary counter is not equal the number of vertices for the graphics primitive, processing continues at decision 860 where a determination is made as to whether the secondary counter is nonzero. If the secondary counter is zero, processing ends at 899.

If the secondary counter is nonzero, processing continues at block 865 where the graphics primitive is duplicated and reflected. In some embodiments, the graphics primitive may be reflected by changing the sign of the spatial components of the vertices of the graphics primitives.

Processing subsequently ends at 899.

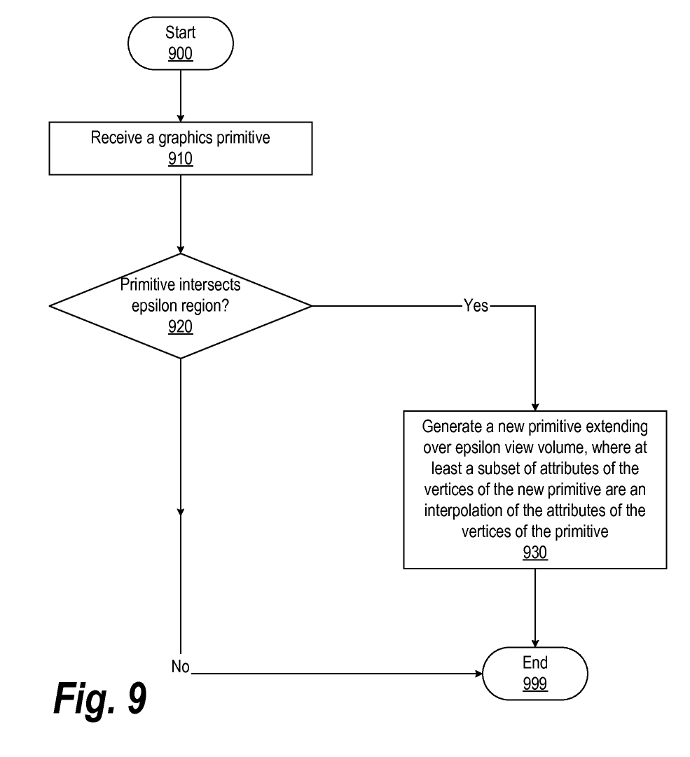

FIG. 9 is a flow diagram illustrating yet another alternative method for processing graphics primitives during hogel rendering, in accordance with some embodiments. It should be noted that, in some embodiments, the methods described here may be performed by the system described in FIG. 1 or FIG. 2.

Processing begins at 900 where, at block 910, a graphics primitive is received. At decision 920, a determination is made as to whether the graphics primitive intersects the epsilon region. The epsilon region may be a substantially small region above and below the holographic plane, for example. If the graphics primitive does not intersect the epsilon region, processing ends at 999.

On the other hand, if the graphics primitive intersects the epsilon region, processing branches to block 930 where a new graphics primitive is generated and added extending over the epsilon view volume or epsilon rendering volume. In some embodiments, at least a subset of the attributes of the vertices of the new graphics primitive may be an interpolation of the attributes of the vertices of the graphics primitive, including depth information.

In some embodiments, the determination as to whether a primitive intersects the epsilon region may be performed as follows. (It should be noted the process that follows represents only one example of how this determination may be accomplished.) A determination may be first made as to whether the graphics primitive intersects the z axis. If the graphics primitive does not intersect the z axis, the processing of the graphics primitive stops. Otherwise, if the graphics primitive intersects the z axis, a determination may be then made as to whether the graphics primitive intersects the z axis within the epsilon region. Again, if the graphics primitive does not intersect the z axis within the epsilon region, the processing of that graphics primitive stops. If the graphics primitive intersects the z axis within the epsilon region, two triangular primitives that form a square, for example, may be added. In some embodiments, the square may extend from −1 to 1 along the x and y axes and may be assigned a z value that is a weighted average of the z values of the original graphics primitive's z values. The z values may be weighted according to the distance of the z axis intersection point to the vertices of the graphics primitive. In some embodiments, the additional graphics primitives may be assigned a homogeneous coordinate (w) value of 1, which is equivalent to an orthographic projection in the epsilon region. The orthographic projection is in contrast to a perspective projection that may be used, for example, in the primary and secondary regions.

Processing subsequently ends at 999.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method for processing graphics primitives, the method comprising point-reflecting a graphics primitive about a point to generate a reflected graphics primitive, the reflected graphics primitive maintaining a depth information of the graphics primitive.

2. The method of claim 1, where point-reflecting the graphics primitive about the point comprises point-reflecting vertices of the graphics primitive about a hogel.

3. The method of claim 2, where the graphics primitive is chosen from a set of one or more graphics primitives, a subset of the one or more graphics primitives located in a primary region, another subset of the one or more graphics primitives located in a secondary region, one of the primary region and the secondary region being primarily in front a hogel surface and another of the primary region and the secondary region being primarily behind the hogel surface, the method further comprising:
determining whether the graphics primitive is, at least partially, in the secondary region; and
point-reflecting the graphics primitive only in response to determining that the graphics primitive is, at least partially, in the secondary region to generate the reflected graphics primitive, the reflected graphics primitive being in the primary region.

4. The method of claim 3, where determining whether the graphics primitive is, at least partially, in the secondary region comprises:
counting the number of vertices of the graphics primitive in the secondary region; and
determining that the graphics primitive is, at least partially, in the secondary region in response to determining that at least one of the vertices of the graphics primitive is in the secondary region.

5. The method of claim 1, where point-reflecting the graphics primitive about the point comprises changing a sign of spatial coordinates of the vertices of the graphics primitive while maintaining a sign and value of a homogeneous coordinate of the vertices of the graphics primitive.

6. The method of claim 3, further comprising:
determining whether the graphics primitive is, at least partially, in a third region, the third region being substantially close to the hogel, the third region being substantially small in the view direction; and
in response to determining that the graphics primitive is, at least partially, in the third region, adding one or more new graphics primitives, the new graphics primitives being in the third region.

7. The method of claim 6, where at least a subset of attributes of the vertices of the new graphics primitives is an interpolation of the attributes of the vertices of the graphics primitive.

8. A system for rendering a hogel, the system comprising:
one or more processors; and
one or more memory units coupled to the one or more processors,
the system being configured to point-reflect a graphics primitive about a point to generate a reflected graphics primitive, the reflected graphics primitive maintaining a depth information of the graphics primitive.

9. The system of claim 8, where the system being configured to point-reflect the graphics primitive about the point comprises the system being configured to point-reflect vertices of the graphics primitive about a hogel.

10. The system of claim 9, where the graphics primitive is chosen from a set of one or more graphics primitives, a subset of the one or more graphics primitives located in a primary region, another subset of the one or more graphics primitives located in a secondary region, one of the primary region and the secondary region being primarily in front a hogel surface and another of the primary region and the secondary region being primarily behind the hogel surface, the system being further configured to:
determine whether the graphics primitive is, at least partially, in the secondary region; and
point-reflect the graphics primitive only in response to determining that the graphics primitive is, at least partially, in the secondary region to generate the reflected graphics primitive, the reflected graphics primitive being in the primary region.

11. The system of claim 10, where the system being configured to determine whether the graphics primitive is, at least partially, in the secondary region comprises the system being configured to:
count the number of vertices of the graphics primitive in the secondary region; and
determine that the graphics primitive is, at least partially, in the secondary region in response to determining that at least one of the vertices of the graphics primitive is in the secondary region.

12. The system of claim 8, where the system being configured to reflect the graphics primitive comprises the system being configured to change the sign of spatial coordinates of the vertices of the graphics primitive while maintaining a sign and a value of a homogeneous coordinate of the vertices of the graphics primitive.

13. The system of claim 10, where the system is further configured to:
determine whether the graphics primitive is, at least partially, in a third region, the third region being substantially close to the hogel, the third region being substantially small in the view direction; and
in response to determining that the graphics primitive is, at least partially, in the third region, add one or more new graphics primitives, the new graphics primitives being in the third region.

14. The system of claim 13, where at least a subset of attributes of the vertices of the new graphics primitives are an interpolation of the attributes of the vertices of the graphics primitive.

15. A computer program product stored on a computer operable medium, the computer program product comprising software code being effective to point-reflect a graphics primitive about a point to generate a reflected graphics primitive, the reflected graphics primitive maintaining a depth information of the graphics primitive.

16. The product of claim 15, where the code being effective to point-reflect the graphics primitive about the point comprises the code being effective to point-reflect vertices of the graphics primitive about a hogel.

17. The product of claim 16, where the graphics primitive is chosen from a set of one or more graphics primitives, a subset of the one or more graphics primitives located in a primary region, another subset of the one or more graphics primitives located in a secondary region, one of the primary region and the secondary region being primarily in front a hogel surface and another of the primary region and the secondary region being primarily behind the hogel surface, the code being further effective to:
determine whether the graphics primitive is, at least partially, in the secondary region; and
point-reflect the graphics primitive only in response to determining that the graphics primitive is, at least partially, in the secondary region to generate the reflected graphics primitive, the reflected graphics primitive being in the primary region.

18. The product of claim 17, where the code being effective to determine whether a graphics primitive from the one or more graphics primitives is, at least partially, in a secondary region comprises the code being effective to:
count the number of vertices of the graphics primitive in the secondary region; and
determine that the graphics primitive is, at least partially, in the secondary region in response to determining that at least one of the vertices of the graphics primitive is in the secondary region.

19. The product of claim 15, where the code being effective to reflect the graphics primitive comprises the code being effective to change the sign of spatial coordinates of the vertices of the graphics primitive while maintaining a sign and a value of a homogeneous coordinate of the vertices of the graphics primitive.

20. The product of claim 17, where the code is further effective to:
determine whether the graphics primitive is, at least partially, in a third region, the third region being substantially close to the hogel, the third region being substantially small in the view direction; and
in response to determining that the graphics primitive is, at least partially, in the third region, add one or more new graphics primitives, the new graphics primitives being in the third region.

21. The product of claim 20, where at least a subset of attributes of the vertices of the new graphics primitives are an interpolation of the attributes of the vertices of the graphics primitive.
